(19) United States
(12) Patent Application Publication
(10) Pub. No.: US 2017/0368762 A1
(43) Pub. Date: Dec. 28, 2017

(54) LASER WELDABLE COMPOSITION AND METHOD USING THE SAME

(71) Applicant: SOLVAY SPECIALTY POLYMERS USA, LLC, Alpharetta, GA (US)

(72) Inventors: Keshav GAUTAM, Duluth, GA (US); Linda M. NORFOLK, CUMMING, GA (US); Suresh R. SRIRAM, AURORA, IL (US); Jiqiang XIA, Alpharetta, GA (US)

(73) Assignee: SOLVAY SPECIALTY POLYMERS USA, LLC, Alpharetta, GA (US)

(21) Appl. No.: 15/538,336

(22) PCT Filed: Dec. 11, 2015
(86) PCT No.: PCT/EP2015/079479

§ 371 Date: Jun. 21, 2017

Related U.S. Application Data
(60) Provisional application No. 62/095,550, filed on Dec. 22, 2014.

(51) Int. Cl. B29C 65/16; B29C 65/00; C08K 7/14; B29K 77/00

(52) U.S. Cl. CPC B29C 65/1616; C08K 7/14; B29C 66/73772; B29C 66/73921; B29C 65/1635; B29C 66/73361; B29C 66/73117; B29C 65/1677; B29K 2077/00

(57) ABSTRACT

A laser-weldable composition and method using the same, said composition comprising at least one amorphous polyamide made from the polycondensation of at least an acyclic aliphatic diamine comprising at least 10 carbon atoms and/or at least an acyclic aliphatic diacid comprising at least 10 carbon atoms, and at least a phthalic acid selected from the group consisting of terephthalic acid and isophthalic acid, at least one flat glass fiber; and at least one organic dye which absorbs radiation at a wavelength from 800 to 1400 nm.

### CROSS REFERENCE TO RELATED APPLICATION

This application claims priority to U.S. provisional patent application No. U.S. 62/095,550 filed on Dec. 22, 2014, the whole content of which being incorporated herein by reference for all purposes.

### FIELD OF THE INVENTION

This invention relates to a laser-weldable composition comprising at least one amorphous polyamide derived from the polycondensation of a mixture of certain monomers detailed hereafter, at least one flat glass fiber; and at least one organic dye.

### BACKGROUND

In recent years many fabrication methods have been designed to form complicated shapes of polymer compositions. However, there are certain limitations to these existing methods. Many fabrication methods rely on adhesives for their sealing properties, but these are time-consuming and costly, and pose environmental concerns due to the use of volatile solvents. Ultrasonic welding or spin welding suffer from limitations on the shape and size of the objects bonded together, and occasionally show insufficient bonding strength. Vibration welding is often unattractive due to the inability to effectively control product appearance and flash, thereby limiting usage to certain applications.

Hence, the laser welding is increasingly attractive as a method to better cope with these drawbacks. In laser welding, a laser is irradiated through a first transmitting part onto a second absorptive part. The energy of the laser accumulated on the contacting part of the absorptive part heats and melts the contacting part and the transmitting part is also heated and melted through heat transfer. The result of this operation is that the parts are easily and strongly joined together. Another benefit to laser welding is that it increasingly offers freedom of choice in designing the shape of the joined articles.

Several important laser welding methods rely on Nd:YAG lasers (or known simply as YAG lasers) or diode lasers as the laser beam source, and these lasers emit light in the near infrared region. The diode laser techniques have become particularly advanced in recent years and diode lasers with higher output power can be obtained at lower cost.

Non-colored resins have been mainly used as the transmitting resin material. The use of such materials limits their applicability for articles of various colors demanded in the automotive industry and electric/electronic industries. Of particular interest, the use of black material in these applications is not satisfactorily popularized at this time using conventional laser welding operations. Additionally, there are some suggestions that black pigment can be diluted and utilized in part of the transmitting resin or even using materials in a thinner shape to facilitate transmission. However such approaches cannot ensure the satisfactory appearance and properties of the resulting part. There are still other examples suggesting the addition of carbon black to the absorptive resin as an approach, leading to bicolored welded articles.

However, there is still a need for a colored laser-weldable polyamide composition suitable to be used in laser-welding methods, and in particular for a colored transmitting laser-weldable polyamide composition, suitable for the manufacture of single colored welded articles.

### SUMMARY OF THE INVENTION

The present invention addresses the above detailed needs and relates to a laser-weldable composition comprising:
at least one amorphous polyamide derived from the polycondensation of a mixture of monomers comprising at least one diamine and at least one diacid, said mixture comprising (i) at least 10 mol. % of at least an acyclic aliphatic diamine comprising at least 10 carbon atoms and/or at least an acyclic aliphatic diacid comprising at least 10 carbon atoms, based on the total number of moles of diamines or diacids; and (ii) at least 10 mol. % of a diacid selected from the group consisting of terephthalic acid and isophthalic acid, based on the total number of moles of diacids;
at least one flat glass fiber; and
at least one organic dye.

The inventors have discovered that the combination of a specific amorphous polyamide with flat glass fibers and an organic dye allows for the manufacture of laser-weldable composition solves the problem of finding transmitting/absorptive polymer compositions being of the same color.

The invention also pertains to an article comprising at least two laser-weldable thermoplastic components comprising the above mentioned laser-weldable composition.

Another aspect of the present invention relates to a method of laser-welding at least two components, comprising:
a. contacting at least a portion of a surface of a first laser-weldable component comprising the laser-weldable composition according to claim 13 that absorbs visible light with wavelengths of from 390 to 700 nm and transmits infrared radiation with wavelengths of from 800 nm to 1400 nm (component 1), with at least a portion of a surface of a second laser-weldable component comprising the laser-weldable composition according to claim 14 that absorbs infrared radiation with wavelengths of from 800 nm to 1400 nm (component 2);
b. welding components 1 and 2 together by irradiating with near-infrared radiation having wavelengths of from 800 nm to 1400 nm through said component 1 to the component 2.

### DETAILED DESCRIPTION OF THE INVENTION

### The Amorphous Polyamide

The laser-weldable composition of the present invention comprises at least one amorphous polyamide. The term “polyamide” is generally understood to indicate a polymer comprising recurring units deriving from the polycondensation reaction of at least one diamine and at least one diacid and optionally from at least one amino carboxylic acid or lactam. The amount of the said recurring units is of at least 50% by moles, preferably at least 75% by moles, more preferably 90% by moles, with respect to the total moles of recurring units. Preferred polyamides are those consisting essentially of recurring units, as above detailed.

The term “amorphous” is intended to denote a polymer having a heat of fusion of at most 5.0 J/g, preferably at most 3.0 J/g and particularly preferred at most 1.0 J/g, when measured by Differential Scanning calorimetry (DSC) at a heating rate of 20° C./min, according to ASTM D3418-12.

The amorphous polyamide is advantageously present in the laser-weldable composition according to the present invention in an amount of at least 20% by weight, preferably at least 30% by weight, more preferably at least 35% by weight, and most preferably at least 40% by weight, based on the total weight of the laser-weldable composition. On the other hand, said amorphous polyamide is advantageously present in said laser-weldable composition in an amount of at most 70% by weight, preferably at most 65% by weight, more preferably at most 60% by weight, and most preferably at most 55% by weight, based on the total weight of the laser-weldable composition. Excellent results were obtained when the amorphous polyamide was present in the laser-weldable composition in an amount of from 40% to 60% by weight, based on the total weight of the laser-weldable composition.

The amorphous polyamide has advantageously a glass transition temperature (Tg) of at most 210° C., preferably at most 200° C., more preferably at most 190° C. and most preferably at most 180° C. On the other hand, it has a glass transition temperature (Tg) of advantageously at least 90° C., preferably at least 100° C., more preferably at least 110° C. and most preferably at least 120° C. The glass transition temperature is thereby determined by means of Differential Scanning calorimetry (DSC) at a heating rate of 20° C./min according to ASTM E1356-08. Excellent results were obtained when the amorphous polyamide had a glass transition temperature (Tg) of at least 120° C. and a most 180° C., preferably of at least 130° C. and at most 160° C.

The recurring units of the amorphous polyamide are derived from the polycondensation of a mixture of monomers comprising at least one diamine and at least one diacid, said mixture comprising:
(i) at least 10 mol. % of at least an acyclic aliphatic diamine comprising at least 10 carbon atoms and/or at least an acyclic aliphatic diacid comprising at least 10 carbon atoms, based on the total number of moles of diamines or diacids; and
(ii) at least 10 mol. % of a diacid selected from the group consisting of terephthalic acid (TA) and isophthalic acid (IA), based on the total number of moles of diacids.

The term “diacid” is intended to denote a dicarboxylic acid, or a derivative thereof. Derivatives of said diacid are notably acid halogenides, especially chlorides, acid anhydrides, acid salts, acid amides and the like. The herein used expression “derivative thereof” when used in combination with the expressions “carboxylic acid”, “dicarboxylic acid”, “amine” or “diamine” is intended to denote whatever derivative thereof which is susceptible of reacting in polycondensation conditions to yield an amide bond.

The at least an acyclic aliphatic diamine comprising at least 10 carbon atoms may be selected from the group consisting of 1,10-diaminodecane, 1,8-diamino-1,3-dimethyloctane, 1,8-diamino-1,4-dimethyloctane, 1,8-diamino-2,4-dimethyloctane, 1,8-diamino-3,4-dimethyloctane, 1,8-diamino-4,5-dimethyloctane, 1,8-diamino-2,2-dimethyloctane, 1,8-diamino-3,3-dimethyloctane, 1,8-diamino-4,4-dimethyloctane, 1,6-diamino-2,4-diethylhexane, 1,9-diamino-5-methylnonane, 1,11-diaminoundecane, 1,12-diaminododecane, 1,13-diaminotridecane, 1,14-diaminotetradecane, 1,15-diaminopentadecane and 1,16-diaminohexadecane. It is preferably selected from the group consisting of 1,10-diaminodecane, 1,11-diaminoundecane, 1,12-diaminododecane, 1,14-diaminotetradecane. Most preferably, it is selected from 1,10-diaminodecane, 1,11-diaminoundecane and 1,12-diaminododecane. The acyclic aliphatic diamine comprises preferably from 10 to 12 carbon atoms, more preferably from 10 to 12 carbon atoms. Excellent results were obtained when using 1,10-diaminodecane (or 1,10-decamethylenediamine—DMDA) and 1,12-diaminododecane (or 1,12-dodecamethylenediamine—DDDA).

If the acyclic aliphatic diamine comprising at least 10 carbon atoms is present in the mixture of monomers, it is preferably present in an amount of at least 15 mol %, more preferably at least 20 mol %, still more preferably at least 25 mol % and most preferably at least 30 mol %, based on the total amount of all diamines present. Also, it is preferably present in the mixture of monomers in an amount of at most 90 mol %, more preferably at most 85 mol %, still more preferably at most 80 mol % and most preferably at most 75 mol %, based on the total amount of all diamines present. Excellent results were obtained when the acyclic aliphatic diamine at least 10 carbon atoms was present in the mixture of monomers in an amount of 45-65 mol %, based on the total amount of all diamines present.

The acyclic aliphatic diacid comprising at least 10 carbon atoms may be selected from the group consisting of sebacic acid [HOOC—(CH₂)₈—COOH], undecandioic acid [HOOC—(CH₂)₉—COOH], dodecandioic acid [HOOC—(CH₂)₁₀—COOH], tridecandioic acid [HOOC—(CH₂)₁₁—COOH], tetradecandioic acid [HOOC—(CH₂)₁₂—COOH], pentadecandioic acid [HOOC—(CH₂)₁₃—COOH] and hexadecandioic acid [HOOC—(CH₂)₁₄—COOH]. The acyclic aliphatic diacid comprises preferably from 10 to 16 carbon atoms, more preferably from 10 to 12 carbon atoms. Most preferably, it is selected from sebacic acid, undecandioic acid and dodecandioic acid. Excellent results were obtained when using sebacic acid.

If the acyclic aliphatic diacid comprising at least 10 carbon atoms is present in the mixture of monomers, it is preferably present in an amount of at least 15 mol %, more preferably at least 20 mol %, still more preferably at least 25 mol % and most preferably at least 30 mol %, based on the total amount of all diacids present. Also, it is preferably present in the mixture of monomers in an amount of at most 90 mol %, more preferably at most 85 mol %, still more preferably at most 80 mol % and most preferably at most 75 mol %, based on the total amount of all diacids present. Excellent results were obtained when the acyclic aliphatic diacid comprising at least 10 carbon atoms was present in the mixture of monomers in an amount of 20-60 mol %, based on the total amount of all diacids present.

The mixture of monomers also comprises at least 10 mol. %, preferably at least 40 mol. %, more preferably at least 60 mol. %, still more preferably at least 80 mol. %, yet more preferably at least 90 mol. %, and most preferably at least 95 mol. %, of a diacid selected from the group consisting of terephthalic acid (TA) and isophthalic acid (IA), based on the total number of moles of diacids. In a preferred embodiment, isophthalic acid (IA) and terephthalic acid (TA) are both present in the mixture of monomers. Excellent results were obtained when both IA and TA were present in an amount of from 25 mol % to 100 mol %, based on the total amount of all diacids present.

In addition to the at least acyclic aliphatic diacid comprising at least 10 carbon atoms, the terephthalic acid (TA) and/or the isophthalic acid (IA) described above, the above described mixture of monomers can further comprise additional diacids different from the above.

The additional diacids may be aromatic or aliphatic. The term “aromatic diacid” is intended to denote a dicarboxylic acid, or a derivative thereof comprising one or more than one aromatic group. Non limitative examples of aromatic diacids are notably phthalic acids, including 5-tert-butyl isophthalic acid, orthophthalic acid (OA), naphtalenedicarboxylic acids (including 2,6-naphthalene dicarboxylic acid, 2,7-naphthalene dicarboxylic acid, 1,4-naphthalene dicarboxylic acid, 2,3-naphthalene dicarboxylic acid, 1,8-naphthalene dicarboxylic acid and 1,2-naphthalene dicarboxylic acid), 2,5-pyridinedicarboxylic acid, 2,4-pyridinedicarboxylic acid, 3,5-pyridinedicarboxylic acid, 2,2-bis(4-carboxyphenyl)propane, bis(4-carboxyphenyl)methane, 2,2-bis(4-carboxyphenyl)hexafluoropropane, 2,2-bis(4-carboxyphenyl)ketone, 4,4′-bis(4-carboxyphenyl)sulfone, 2,2-bis(3-carboxyphenyl)propane, bis(3-carboxyphenyl)methane, 2,2-bis(3-carboxyphenyl)hexafluoropropane, 2,2-bis(3-carboxyphenyl)ketone, bis(3-carboxyphenoxy)benzene. Non limitative examples of aliphatic diacids are notably oxalic acid (HOOC—COOH), malonic acid (HOOC—CH₂—COOH), succinic acid [HOOC—(CH₂)₂—COOH], glutaric acid [HOOC—(CH₂)₃—COOH], 2,2-dimethyl-glutaric acid [HOOC—C(CH₃)₂—(CH₂)₂—COOH], adipic acid [HOOC—(CH₂)₄—COOH], 2,4,4-trimethyl-adipic acid [HOOC—CH(CH₃)—CH₂—C(CH₃)₂—CH₂COOH], pimelic acid [HOOC—(CH₂)₅—COOH], suberic acid [HOOC—(CH₂)₆—COOH], azelaic acid [HOOC—(CH₂)₇—COOH], 1,4-norbornane dicarboxylic acid, 1,3-adamantane dicarboxylic acid, cis and/or trans cyclohexane-1,4-dicarboxylic acid and cis and/or trans cyclohexane-1,3-dicarboxylic acid.

In addition to the at least acyclic aliphatic diamine comprising at least 10 carbon atoms, the above described mixture of monomers can further comprise additional diamines different from the above. The additional diamines may be aliphatic or aromatic. The term “aromatic diamine” is intended to denote a diamine, or a derivative thereof comprising one or more than one aromatic group. Non limitative examples of said additional aliphatic diamines are notably 1,2-diaminoethane, 1,2-diaminopropane, propylene-1,3-diamine, 1,3-diaminobutane, 1,4-diaminobutane, 1,5-diaminopentane, 1,4-diamino-1,1-dimethylbutane, 1,4-diamino-1-ethylbutane, 1,4-diamino-1,2-dimethylbutane, 1,4-diamino-1,3-dimethylbutane, 1,4-diamino-1,4-dimethylbutane, 1,4-diamino-2,3-dimethylbutane, 1,2-diamino-1-butylethane, 1,6-diaminohexane, 1,7-diaminoheptane, 1,8-diamino-octane, 1,6-diamino-2,5-dimethylhexane, 1,6-diamino-2,4-dimethylhexane, 1,6-diamino-3,3-dimethylhexane, 1,6-diamino-2,2-dimethylhexane, 1,9-diaminononane, 2-methylpentamethylenediamine, 1,6-diamino-2,2,4-trimethylhexane, 1,6-diamino-2,4,4-trimethylhexane, 1,7-diamino-2,3-dimethylheptane, 1,7-diamino-2,4-dimethylheptane, 1,7-diamino-2,5-dimethylheptane, 1,7-diamino-2,2-dimethylheptane and bis(3-methyl-4aminocyclohexyl)-methane. Non limitative examples of said additional aromatic diamines are notably diamines selected from the group consisting of meta-phenylene diamine, p-phenylene diamine (PPD), 3,4′-diaminodiphenyl ether (3,4′-ODA), 4,4′-diaminodiphenyl ether (4,4′-ODA), meta-xylylene diamine and para-xylylene diamine.

Further, in addition to the above described monomers, still other additional monomers may be present in the mixture of monomers. For example, acyclic aliphatic aminoacid may be present and notably selected from the group consisting of naturally occurring aminoacids (such as histidine, isoleucine, leucine, lysine, methionine, phenylalanine, threonine, tryptophan, valine, alanine, asparagine, aspartic acid, glutamic acid, arginine, cysteine, glutamine, tyrosine, glycine, ornithine, proline, and serin), other non natural amino acids such as hydroxytryptophan, and 1-aminodecanoic acid, 1-aminoundecandecanoic acid, 1-aminododecanoic acid. Also, lactams may be present as additional monomers. Non limitative examples of said lactams may be selected from the group consisting of [beta]-propiolactam, [gamma]-butyrolactam, [delta]-valerolactam, [epsilon]-caprolactam, and [omega]-lauryl lactam.

In a preferred embodiment, the amorphous polyamide is derived from the above mentioned mixture of monomers further comprising at least one monomer selected from cycloaliphatic diamines and cycloaliphatic diacids. Said cycloaliphatic diamines or diacids comprise preferably from 6 to 12 carbon atoms. In still a preferred embodiment, the amorphous polyamide is derived from the above mentioned mixture of monomers further comprising at least one cycloaliphatic diamine.

The term “cycloaliphatic diamine” is intended to denote a compound comprising two amino moieties and at least one cycloaliphatic group or a derivative thereof. The at least one cycloaliphatic diamine comprises from 6 to 12 carbon atoms, preferably from 8 to 10 carbon atoms. It is preferably selected from the group consisting of 1,3-diaminocyclohexane, 1,4-diaminocyclohexane, 1,3-bis(aminomethyl)cyclohexane (BAC), 1,4-bis(aminomethyl)cyclohexane, and isophorononediamine (IPDA). Most preferably it is 1,3-bis(aminomethyl)cyclohexane (BAC). Excellent results were also obtained when BAC and/or IPDA were present in the mixture of monomers.

The cycloaliphatic diamine is advantageously present in the mixture of monomers in an amount of at least 10 mol %, preferably at least 15 mol %, more preferably at least 20 mol %, still more preferably at least 25 mol % and most preferably at least 30 mol %, based on the total amount of all diamines present. In parallel, it is advantageously present in the mixture of monomers in an amount of at most 90 mol %, preferably at most 85 mol %, more preferably at most 80 mol %, based on the total amount of all diamines present. Excellent results were obtained when the cycloaliphatic diamine comprising from 6 to 12 carbon atoms was present in the mixture of monomers in an amount of at least 30 mol % and at most 80 mol %.

Preferred embodiments of the amorphous polyamide are those wherein it comprises, preferably consists essentially of:
recurring units formed by the polycondensation reaction between TA, IA, BAC and DMDA;
recurring units formed by the polycondensation reaction between TA, IA, BAC and DDDA;
recurring units formed by the polycondensation reaction between IA, BAC and DMDA;
recurring units formed by the polycondensation reaction between IA, sebacic acid, BAC and DMDA;
recurring units formed by the polycondensation reaction between TA, IA, IPDA and DMDA, or
recurring units formed by the polycondensation reaction between TA, sebacic acid, BAC and IPDA.

The amorphous polyamide may also be endcapped by any end capping agent. The term “end capping agent” indicates one or more compound which reacts with the ends of a polycondensate, capping the ends and limiting the polymer molecular weight. The end capping agent is typically selected from the group consisting of an acid comprising only one reactive carboxylic acid group [acid (MA)] and an amine comprising only one reactive amine group [amine (MN)], and mixtures thereof. The expression “acid/amine comprising only one reactive carboxylic acid/amine group” is intended to encompass not only mono-carboxylic acids or mono-amines but also acids comprising more than one carboxylic acid group or derivative thereof and amines comprising more than one amine or derivative thereof, but wherein only one of said carboxylic acid/amine group has reactivity with the polycondensate obtained from the polycondensation of the above mentioned diamine(s) and diacid(s).

Among suitable [acids (MA)] mention can be notably made of acetic acid, propionic acid, butyric acid, valeric acid, caproic acid, caprylic acid, lauric acid, stearic acid, cyclohexanecarboxylic acid and benzoic acid. [Acid (MA)] is preferably selected from acetic acid, benzoic acid and mixture thereof.

Among suitable [amines (MN)] mention can be notably made of methylamine, ethylamine, butylamine, octylamine, aniline, toluidine, propylamine, hexylamine, dimethylamine and cyclohexylamine.

The end-capping agent is generally used in an amount of more than 0.1 mol %, preferably more than 0.5 mol %, still more preferably more than 0.8 mol %, even more preferably more than 1 mol %, based on the total number of moles of the diacids, if [acids (MA)] are used as end-capping agent or based on the total number of the diamines, if [amines (MN)] are used as end-capping agent. The end-capping agent is generally used in an amount of less than 6.5 mol %, preferably less than 6.2 mol %, still more preferably less than 6 mol %, even more preferably less than 5.5 mol %, based on the total number of moles of the diacids, if [acids (MA)] are used as end-capping agent or based on the total number of the diamines, if [amines (MN)] are used as end-capping agent.

### The Flat Glass Fiber

The laser-weldable composition of the present invention comprises at least one flat glass fiber.

The term “flat glass fiber” is intended to denote a glass fibers with a noncircular cross-sectional area and a dimension ratio of the main cross-sectional axis to the secondary cross-sectional axis of 2 to 6, in particular 3 to 6, most especially preferably from 3.5 to 5.

In a first embodiment, the flat glass fibers used according to the present are characterized by a ratio of the cross-sectional axes perpendicular to one another which is greater than or equal to 2, preferably greater than or equal to 3, more preferably greater than or equal to 3.5. The glass fibers are advantageously in the form of chopped glass with a length of 2 mm to 50 mm.

In the laser-weldable composition according to the invention all types of glass fibers such as A, C, D, E, M, R and S glass fibers or any mixtures thereof can be used. E-glass fibers, S-glass fibers are preferably used, while E-glass fibers are most preferred.

In an alternative embodiment of the invention, only flat glass fibers having an elongated shape and an almost rectangular cross section are used, the aspect ratio, i.e., the ratio of dimensions of the main axis/cross-sectional axis to the secondary/cross-sectional axis is 2 to 6, in particular 3 to 6, most especially preferably from 3.5 to 5.0. Cocoon-shaped glass fibers or so-called glass fiber cocoons (cocoon fibers), i.e., glass fibers having an elongated or oval shape or a curved shape with at least one constricted section are not used in this embodiment.

The flat glass fiber is advantageously present in the laser-weldable composition according to the present invention in an amount of at least 20% by weight, preferably at least 30% by weight, more preferably at least 35% by weight, and most preferably at least 40% by weight, based on the total weight of the laser-weldable composition. On the other hand, it is advantageously present in the laser-weldable composition according to the present invention in an amount of at most 70% by weight, preferably at most 65% by weight, more preferably at most 60% by weight, and most preferably at most 55% by weight, based on the total weight of the laser-weldable composition. Excellent results were obtained when the flat glass fiber was used in an amount of 30-70 wt. %, preferably of 40-60 wt. %, based on the total weight of the laser-weldable composition.

### The at Least One Organic Dye

The laser-weldable composition of the present invention comprises at least one organic dye. The term “organic dye” is intended to denote carbon-based molecules which absorb visible light with wavelengths of from 390 to 700 nm, imparting therefore colors to said dye.

The organic dye of the laser-weldable composition according to the present invention can either absorb visible light with wavelengths of from 390 to 700 nm and transmits infrared radiation with wavelengths of from 800 nm to 1400 nm, or absorb infrared radiation with wavelengths of from 800 nm to 1400 nm.

The organic dyes absorbing visible light with wavelengths of from 390 to 700 nm and transmits infrared radiation with wavelengths of from 800 nm to 1400 nm may notably be selected from the group consisting of anthracene-based dyes, anthraquinone-based dyes and an organic dye such as perylene-based, perinone-based, heterocycle-based, disazo-based and monoazo-based dyes.

The organic dyes absorbing infrared radiation with wavelengths of from 800 nm to 1400 nm may notably be selected from the group consisting of phthalocyanine-based dyes and polymethine-based dyes.

There are many examples of combinations of mixed dyes useful in this invention. For instance, the combination of blue dye, red dye and yellow dye; the combination of green dye, red dye and yellow dye; the combination of blue dye, green dye and red dye and yellow dye; and the combination of green dye, violet dye and yellow dye can be used. Generally, the dyes which exhibit blue, violet and green colors can be main components to produce the black dyes.

The organic dye is advantageously present in the laser-weldable composition according to the present invention in an amount of at least 0.05% by weight, preferably at least 0.08% by weight, more preferably at least 0.10% by weight, still more preferably at least 0.15% by weight and most preferably at least 0.2% by weight, based on the total weight of the laser-weldable composition. On the other hand, it is advantageously present in the laser-weldable composition according to the present invention in an amount of at most 2.5% by weight, preferably at most 2% by weight, more preferably at most 1% by weight, and most preferably at most 0.5% by weight, based on the total weight of the laser-weldable composition. Excellent results were obtained when the organic dye was used in an amount of 0.06-1 wt. %, preferably of 0.1-0.6 wt. %, based on the total weight of the laser-weldable composition.

In a particular embodiment, the laser-weldable composition may further comprise, in addition to the above mentioned organic dye, at least one pigment, different from the above mentioned organic dye. The presence of such pigments is particularly useful for the manufacture of colored laser-weldable composition absorbing infrared radiation with wavelengths of from 800 nm to 1400 nm. The pigment may be selected from the group consisting of carbon black, zinc sulfide and titanium dioxide. When present, pigments of the laser-weldable composition are advantageously in the form of particles. The shape of the particles is not particularly limited; they may be notably round, flaky, flat and so on.

The weight percent of the pigment in the total weight of the laser-weldable composition is generally of at least 1 wt. %, preferably of at least 2 wt. %, more preferably of at least 4 wt. % and most preferably of at least 8 wt. %. Besides, the weight percent of the pigment in the total weight of the laser-weldable composition generally of at most 20 wt. %, preferably of at most 15 wt. %, more preferably of at most 12 wt. % and most preferably of at most 10 wt. %.

If present, excellent results were obtained when the pigment was used in an amount of 5-15 wt. %, preferably of 8-10 wt. %, based on the total weight of the laser-weldable composition.

The laser-weldable compositions of the present invention may further comprises other polymers than the above described amorphous polyamide. For example, it may comprise polycarbonate, polyethylene glycol, polysulfone, polyesters, polyolefins, polyamideimide, polyimide, PTFE, aliphatic polyamides and aromatic polyamides such as polyphthalamide.

The laser-weldable compositions of the present invention can further contain one or more impact modifiers. The impact modifiers can be reactive with the amorphous polyamide or non-reactive. In certain specific embodiment, the laser-weldable composition contains at least one reactive impact modifier and at least one non-reactive impact modifier. Reactive impact modifiers that may be used include ethylene-maleic anhydride copolymers, ethylene-alkyl (meth)acrylate-maleic anhydride copolymers, ethylene-alkyl (meth)acrylate-glycidyl (meth)acrylate copolymers, and the like. An example of such reactive impact modifier is a random terpolymer of ethylene, methylacrylate and glycidyl methacrylate. Non-reactive impact modifiers that may be blended into the laser-weldable composition generally include various rubber materials, such as acrylic rubbers, ASA rubbers, diene rubbers, organosiloxane rubbers, EPDM rubbers, SBS or SEBS rubbers, ABS rubbers, NBS rubbers and the like. Particular examples of non-reactive impact modifiers include ethyl butylacrylate, ethyl (methyl)acrylate or 2 ethyl hexyl acrylate copolymers.

The laser-weldable compositions of the present invention may optionally be blended with various additives, if necessary, preferably selected from the group consisting of pigments, halogen-containing flame retardant agents, halogen-free flame retardant agents, stabilizers, antioxidants, light protection agents, UV stabilizers, UV absorbers, UV blockers, inorganic heat stabilizers, organic heat stabilizers, conductivity additives, optical brighteners, processing aids, nucleation agents, crystallization accelerators, crystallization inhibitors, flow aids, lubricants, mold-release agents, softeners and mixtures thereof. These additives are added according to conventional techniques and in amounts readily understood by those of skill in the art.

The laser-weldable compositions of the present invention can be obtained by blending the ingredients of said laser-weldable compositions using conventional blending methods, as understood by those of ordinary skill in the art. For example, all the ingredients can be mixed to homogeneity using a mixer such as a blender, kneader, Banbury mixer, roll extruder, etc. to give laser-weldable compositions of the present invention.

Another aspect of the present invention relates to an article comprising at least two laser-weldable thermoplastic components comprising the above detailed laser-weldable composition.

The article according to the present invention comprises advantageously a first component made from a laser-weldable composition that absorbs visible light with wavelengths of from 390 to 700 nm and transmits infrared radiation with wavelengths of from 800 nm to 1400 nm (component 1), and a second component made from a laser-weldable composition that absorbs infrared radiation with wavelengths of from 800 nm to 1400 nm (component 2). Both laser-weldable compositions of components 1 and 2 can be the laser-weldable composition according to the present invention. In a specific embodiment, the laser-weldable composition of component 1 is the laser-weldable composition according to the present invention and the laser-weldable composition of component 2 is a composition having the same color than said laser-weldable composition of component 1.

The molding of the laser-weldable compositions of the present invention into such articles can be carried out by various general methods. For example, molding can be carried out with fabricating machines such as extruders, inject molders and roll mill, using colored pellets. Also, molding can be carried out by mixing pellets or powder of thermoplastic resin having transparency, pulverized colorants and various additives according to needs with an appropriate mixer, followed by using a finishing machine. As the examples of the molding method, the generally utilized molding methods such as injection molding, extruding molding, pressing molding, foaming molding, blow molding, vacuum molding, injection blow molding, rotation molding, calendar molding and solution casting molding can be utilized.

In the case of use for a laser-transmissive part, the laser transmittance of the material for laser welding of the present invention is advantageously of at least 20%, preferably at least 30%, more preferably at least 40%, still more preferably at least 50%, even more preferably at least 60%, yet more preferably at least 70%, and most preferably at least 80%. The laser transmittance as referred to in the present invention is a numerical value obtained by measuring the resin composition shape-formed into 60 mm diameter discs having 2 mm in thickness.

Still another aspect of the present invention relates to a method of laser-welding at least two components, comprising:
a. contacting at least a portion of a surface of a first laser-weldable component made from the laser-weldable composition according to claim 13 that absorbs visible light with wavelengths of from 390 to 700 nm and transmits infrared radiation with wavelengths of from 800 nm to 1400 nm (component 1), with at least a portion of a surface of a second laser-weldable component made from the laser-weldable composition according to claim 14 that absorbs infrared radiation with wavelengths of from 800 nm to 1400 nm (component 2);
b. welding components 1 and 2 together by irradiating with near-infrared radiation having wavelengths of from 800 nm to 1400 nm through said component 1 to the component 2.

The welding of components 1 and 2 together is achieved by irradiating with near-infrared radiation having wavelengths of from 800 nm to 1400 nm. Such radiation includes, for example, laser of a glass:neodymium³⁺ laser, a YAG:neodymium³⁺ laser (YAG laser), a ruby laser, a helium-neon laser, krypton laser, an argon laser, an H₂ laser, an N₂ laser and a semiconductor laser. The preferred laser source is a semiconductor laser. The wavelength of laser varies depending on the resin material joined and cannot be indiscriminately specified, but is preferably 800 nm or more. If the wavelength is less than 400 nm, this causes significant deterioration of the resin. YAG (1064 nm) and diode lasers (750-1050 nm) are particularly preferred. Particular preference is given to the use of YAG laser and diode laser of various wavelength. The commonest wavelengths for diode lasers are 808 nm, 940 nm and 980 nm. The laser sources for the laser welding of polymers have generally a power of 30-200 watts, preferably 50-160 watts.

Laser sources which are suitable for the laser welding of the polymers according to the invention are commercially available. Lasers may be utilized singly or in combination with each other, as will be appreciated among those having skill in the art of laser operation. The emissions of laser by the laser source may be continuous or pulsed, with continuous emissions being preferred.

With respect to the laser-weldable composition of component 1 and 2 subject to the laser welding, there is provided in component 1 a laser-weldable composition that is laser-transmitting and another laser-weldable composition in component 2 that is laser-absorptive. By irradiating a laser through the transmitting resin material onto the absorptive resin material attached thereto, the energy of the laser accumulated on the contact surface of the absorptive resin material heats and melts the contact area. The transmitting resin material is also heated/melted through heat transfer, so that the resin materials are easily and strongly bonded together. The laser may directly irradiate the welding area or may be guided to the contact area using an optical apparatus such as a mirror or optical fiber. These and other techniques are employed as appropriate to the individual welding operation, and are selected by those having skill in this field.

Component 1 transmits at least partially infrared radiation with wavelengths of from 800 nm to 1400 nm. For example, it has a thickness of 0.1 to 5 mm, preferably of 0.2 to 4 mm, especially preferably ranging from 0.5 to 3.5 mm, eminently preferably ranging from 0.8 to 3 mm. Component 2 faces away from the laser radiation, and can at least partially absorb infrared radiation with wavelengths of from 800 nm to 1400 nm. For example, component 2 has a thickness of 0.5 to 10 mm, preferably of 0.8 to 3 mm. Component 2 has preferably the same thickness than component 1.

The intensity, density and irradiating area of the laser is selected to appropriately carry out the heating and melting of the bonding surface. These are adjusted in such a way that the resulting bonding is obtained with the strength required for the application of interest. If it is too weak, a sufficient heating melting cannot be realized. Conversely if it is too strong, degradation of resin may be induced.

The junction portion of the at least two components 1 and 2 positioned in contact with each other, and a predetermined amount of laser beam is focused and transmitted, which partially melts and bonds the at least two components together. If a multiple number of points, lines or surfaces are to be welded, the laser may be moved in sequence to irradiate the bonding surface, or a multiple laser sources may be used to irradiate simultaneously. If necessary, pressure can be further applied on the bonding surface.

The welded seam can here follow a straight line, but also exhibit any shape desired; it can be situated in a region where the two components 1 and 2 flatly adjoin each other, but can also be located in an area where a projection or rib of the one component comes to lie on a surface of the other component, for example, or in an area where two correspondingly arranged projections or ribs or even a groove and comb of the two components adjoin each other. Therefore, the welded seam can be both a spot welded seam, as well as a long, drawn out welded seam. A spot welded seam can be generated by a pulsed laser, for example.

The amorphous polyamide of the laser-weldable composition of component 1 and 2 may be of the same or different.

The transmission rates of the laser-weldable composition of component 1 for laser transmission are preferably measured between 800 and 1400 nm, more preferably between 940 and 1064 nm.

In a particular embodiment, the laser-weldable composition of component 1 has advantageously a transmittance at 450 nm of at most 5%, preferably at most 3%, more preferably at most 1%, and a transmittance at 1064 nm of at least 60%, preferably at least 65%, more preferably at least 68%, when measured on a 2 mm thick sample.

### EXAMPLES

The following commercially available materials were used:
PA1: amorphous polyamide made from the polycondensation of hexamethylenediamine, terephthalic acid, isophthalic acid, BAC and DMDA.
PA2: crystalline polyamide, Amodel PPA A-4000 made from PA6T/66.
GF-1: 995 glass fiber commercially available from OCV, chopped Advantex E-glass, 10 micron diameter, 4 mm cut length, circular cross section fibers.
GF-2: CSG 3PA820 from Nittobo—non-circular cross section fibers (flat fibers).
Organic dye: AB91620395 commercially available from Clariant Masterbatches, 15 wt. % of organic dye in a in PA6 masterbatch

### General Procedure for the Preparation of the Compositions CE1, CE2 and E1-E5:

The polyamide resins PA1 or PA2 described above were fed to the first barrel of a ZSK-26 twin screw extruder comprising 12 zones via a loss in weight feeder. The barrel settings were in the range of 280-330° C. and the resins were melted before zone 5. The other ingredients were fed at zone 5 through a side stuffer via a loss in weight feeder. The screw rate ranged from 180-250 rpm. The extrudates were cooled and pelletized using conventional equipment. The results are summarized in Table 1, indicating each ingredient used, and their amount given in weight %.

TABLE 1
nature and quantities of the ingredients used

| | CE1 | CE2 | CE3 | CE4 | E1 | E2 | E3 | E4 | E5 |
|---|---|---|---|---|---|---|---|---|---|
| Polyamides | | | | | | | | | |
| PA1 | 48.5 | 48.5 | | | 48 | 47.5 | 47 | 46.5 | 45.5 |
| PA2 | | | 48.5 | 48.5 | | | | | |
| Reinforcing fillers | | | | | | | | | |
| GF-1 | 50 | | 50 | | | | | | |
| GF-2 | | 50 | | 50 | 50 | 50 | 50 | 50 | 50 |
| Additive Package | 1.5 | 1.5 | 1.5 | 1.5 | 1.5 | 1.5 | 1.5 | 1.5 | 1.5 |
| Organic dye | | | | | 0.5 | 1 | 1.5 | 2 | |

### Mechanical Tests

All the test bodies were used in the dry state. For this purpose, the test bodies were stored after the injection molding for at least 48 h at room temperature in dry surroundings. Using the obtained pellets of each resin composition, ISO tensile test pieces (10 mm×10 mm×4 mm) were molded. The tensile properties of the materials were measured as per ISO 527 test procedure, while the notched and unnotched Izod impact strengths were measured as per ISO 180 test procedure. The results obtained are summarized in Table 2.

TABLE 2
mechanical properties of the compounds

| | Units | CE1 | CE2 | CE3 | CE4 | E1 | E2 | E3 | E4 | E5 |
|---|---|---|---|---|---|---|---|---|---|---|
| Tensile Strength | MPa | 216 | 220 | 244 | 242 | 217 | 214 | 216 | 216 | 216 |
| Tensile Modulus | GPa | 15.6 | 16.0 | 18.2 | 18.8 | 15.6 | 15.6 | 15.7 | 15.5 | 15.6 |
| Strain at break | % | 2.5 | 2.1 | 2.1 | 1.8 | 2.1 | 2.0 | 2.1 | 2.1 | 2.1 |
| Unnotched Izod | kJ/m2 | 68.4 | 60.6 | 65 | 53.9 | 60.2 | 64.2 | 63.7 | 61.7 | 65.3 |
| Notched Izod | kJ/m2 | 11.6 | 13.6 | 10.1 | 11.7 | 14.1 | 14.4 | 14.8 | 13.8 | 14.0 |

### Light Transmittance

Compounds CE1-CE4 and E1-E5 were molded in thin discs (of 63.5 mm diameter square and 2 mm in thickness) and their light transmittance was measured from 450 to 1064 nm using a Perkin Elmer Lamda 950 spectrophotometer. Results are shown in Table 3 where the % transmission is reported as a function of wavelength.

TABLE 3
light transmittance results

| | % | | | | | | | | | |
|---|---|---|---|---|---|---|---|---|---|---|
| | Transmission | CE1 | CE2 | CE 3 | CE 4 | E1 | E2 | E3 | E4 | E5 |
| Visible | 450 nm | 24.7 | 36.8 | 6.1 | 10.2 | 0.11 | 0.06 | 0.05 | 0.02 | 0.02 |
| wavelength | | | | | | | | | | |
| Visible | 550 nm | 41.2 | 53.2 | 14.6 | 21.8 | 0.37 | 0.06 | 0.06 | 0.05 | 0.05 |
| wavelength | | | | | | | | | | |
| Laser | 940 nm | 55.0 | 69.8 | 19.7 | 28.5 | 67.5 | 69.0 | 67.7 | 65.9 | 66.4 |
| wavelength | | | | | | | | | | |
| Laser | 1064 nm | 58.2 | 72.4 | 20.6 | 30.1 | 69.8 | 71.4 | 70.3 | 68.6 | 69.2 |
| wavelength | | | | | | | | | | |

Compounds E1-E5 show very high transmittances in the near infrared radiation (with wavelengths within the range of from 800 nm to 1400 nm) commonly used in the industry for laser welding. In particular, one can see from the results summarized in Table 3 that all 5 compounds reach transmittance levels of at least 65% at 940 and 1064 nm, while absorbing the wavelengths within the visible wavelengths range at 450 and 550 nm.

The laser-weldable compositions according to the present invention may be advantageously used in the industry to manufacture laser-welded articles by laser-welding at least two components having the same color.

Should the disclosure of any patents, patent applications, and publications which are incorporated herein by reference conflict with the description of the present application to the extent that it may render a term unclear, the present description shall take precedence.

1-15. (canceled)

16. A laser-weldable composition comprising:
at least one amorphous polyamide derived from the polycondensation of a mixture of monomers comprising at least one diamine and at least one diacid, said mixture comprising (i) at least 60 mol. % of at least an acyclic aliphatic diamine comprising at least 10 carbon atoms, based on the total number of moles of diamines or diacids; and (ii) at least 30 mol. % of a diacid selected from the group consisting of terephthalic acid, isophthalic acid and a combination thereof, based on the total number of moles of diacids;
at least one flat glass fiber; and
at least one organic dye.
wherein
the mixture of monomers further comprises at least one cycloaliphatic diamine comprising 6 to 12 carbon atoms.

17. The laser-weldable composition according to claim 16, wherein the amorphous polyamide has a glass transition temperature (Tg) of at least 100° C., preferably at least 120° C., when measured by differential scanning calorimetry (DSC) at a heating rate of 20° C./min according to the ASTM E1356.

18. The laser-weldable composition according to claim 16, wherein the amorphous polyamide is present in an amount of at least 20 wt. %, based on the total weight of the laser-weldable composition.

19. The laser-weldable composition according to claim 16, wherein the amorphous polyamide is present in an amount of at most 60 wt. %, based on the total weight of the laser-weldable composition.

20. The laser-weldable composition according to claim 16, wherein the diacid includes terephthalic acid and isophthalic acid.

21. The laser-weldable composition according to claim 20, wherein the at least one cycloaliphatic diamine is 1,3-bis(aminomethyl)cyclohexane (BAC).

22. The laser-weldable composition according to claim 21, wherein the cycloaliphatic diamine or diacid is present in an amount of at least 10 mol. %, based on the total number of moles of diamines or diacids.

23. The laser-weldable composition according to claim 16, wherein the flat glass fiber is present in an amount of at least 20 wt. %, based on the total weight of the laser-weldable composition.

24. The laser-weldable composition according to claim 16, wherein the flat glass fiber is present in an amount of at most 60 wt. %, based on the total weight of the laser-weldable composition.

25. The laser-weldable composition according to claim 16, wherein the organic dye is present in an amount of at least 0.05 wt. %, based on the total weight of the laser-weldable composition.

26. The laser-weldable composition according to claim 16, wherein the organic dye is present in an amount of at most 15 wt. %, based on the total weight of the laser-weldable composition.

27. The laser-weldable composition according to claim 16, wherein (i) the organic dye absorbs visible light with wavelengths of from 390 to 700 nm and transmits infrared radiation with wavelengths of from 800 nm to 1400 nm, (ii) the organic dye absorbs infrared radiation with wavelengths of from 800 nm to 1400 nm, or both (i) and (ii).

28. An article comprising at least a first laser-weldable thermoplastic component and a second laser-weldable thermoplastic component, the first and second laser-weldable components independently comprising the laser-weldable composition according to claim 27.

29. A method of making the article of claim 28, the method comprising:
a. contacting at least a portion of a surface of the first laser-weldable component, wherein the laser-weldable composition of the first laser-weldable component absorbs visible light with wavelengths of from 390 to 700 nm and transmits infrared radiation with wavelengths of from 800 nm to 1400 nm (component 1), with at least a portion of a surface of the second laser-weldable component, wherein the laser-weldable composition of the second laser-weldable component absorbs infrared radiation with wavelengths of from 800 nm to 1400 nm (component 2);
b. welding components 1 and 2 together by irradiating with near-infrared radiation having wavelengths of from 800 nm to 1400 nm through said component 1 to the component 2.
